(19) United States
(12) Patent Application Publication
(10) Pub. No.: US 2024/0364254 A1
(43) Pub. Date: Oct. 31, 2024

(54) METHOD OF INSTALLING A FIXED TILT SOLAR PANEL MOUNTING ASSEMBLY WITH ASCENDING AND DESCENDING PANEL ORIENTATION

(71) Applicant: Gamechange Solar Corp., Norwalk, CT (US)

(72) Inventors: Andrew Barron Worden, Redding, CT (US); Scott Van Pelt, Tarrytown, NY (US); Woo Kim, Little Neck, NY (US)

(73) Assignee: Gamechange Solar Corp., Norwalk, CT (US)

(21) Appl. No.: 18/198,433

(22) Filed: May 17, 2023

Related U.S. Application Data
(60) Provisional application No. 63/345,177, filed on May 24, 2022.

(51) Int. Cl. H02S 20/10

(52) U.S. Cl. CPC H02S 20/10

(57) ABSTRACT

A method of installing stationary structural members of a solar panel racking structure comprises positioning a jig on a surface relative to a datum on the surface, using the jig as a guide and driving a first plurality of stationary structural members into the ground at fixed positions relative to one another, removing the jig from the first plurality of stationary structural members, repositioning the jig to a desired position; and repeating the steps of using the jig as a guide, driving a second plurality of stationary members into the ground and removing the jig.

### CROSS REFERENCE TO RELATED APPLICATIONS

This application claims the benefit of U.S. Provisional Patent Application Ser. No. 63/345,177 filed May 24, 2022, which is hereby incorporated by reference.

### BACKGROUND OF THE INVENTION

### 1. Technical Field

This disclosure relates generally to solar panel installation and, more particularly, to a method of installing apparatuses and assemblies for use in a solar panel installation.

### 2. Background Information

A ground mounted solar panel racking structure can be a fixed tilt system or tracker system. In a fixed tilt system the photovoltaic panels remain in a fixed/constant position. A tracker system regularly reorients the photovoltaic panels to be at an optimal angle to the light from the sun, thereby optimizing the energy output. Each of these systems are typically arranged in an array, with a plurality of stationary structural members mounted into the ground at fixed locations relative to one another to support the racking structure.

Installing the stationary structural members is labor intensive. There is a need for an improved technique for efficiently positioning and installing the stationary structural members.

### SUMMARY OF THE DISCLOSURE

According to an aspect of the disclosure, a method of installing stationary structural members of a solar panel racking structure comprises positioning a jig on a surface relative to a datum on the surface, using the jig as a guide and driving a first plurality of stationary structural members into the ground at fixed positions relative to one another, removing the jig from the first plurality of stationary structural members, repositioning the jig to a desired position relative to the datum, and repeating the steps of using the jig as a guide, driving a second plurality of stationary members into the ground and removing the jig.

Using the jig as a guide and driving may comprise driving each of the first plurality of stationary members into the ground through an associated one of a plurality of guides located on the jig.

Using the jig as a guide and driving may comprise driving each of the first plurality of stationary members into the ground through an associated one of a plurality of eyelets located on the jig.

Using the jig as a guide and driving may comprise driving each of the first plurality of stationary members into the ground through an associated one of a plurality of tubing segments located on the jig.

Removing the jig may comprise lifting the jig so each of the plurality of guides no longer surrounds its associated one of the first plurality of stationary structural members.

The jig may be rectangular and the guides may be mounted to exterior corners of the rectangular jig, and the step of using the jig as a guide and driving a first plurality of stationary structural members into the ground may comprise driving a first and a second stationary structural member of the first plurality of stationary structural members into the ground such that a top surface of each of the first and the second stationary structural members is a height H1 above the ground, and driving a third and a fourth stationary structural member of the first plurality of stationary structural members into the ground such that a top surface of each of the third and the fourth stationary structural members is a height H2 above the ground, where height H1 is not equal to height H2.

According to another aspect of the disclosure, a method of installing stationary structural members of a solar panel racking structure comprises positioning a jig on a surface relative to a datum on the surface, using the jig as a guide and driving a first plurality of stationary structural members into the ground at fixed positions relative to one another, removing the jig from the first plurality of stationary structural members, repositioning the jig to a desired position relative to the first plurality of stationary structural members, and repeating the steps of using the jig as a guide, driving a second plurality of stationary members into the ground and removing the jig.

According to yet another aspect of the disclosure, a method of installing stationary structural members of a solar panel racking structure comprises positioning a jig on a surface relative to a datum on the surface, using the jig as a guide and driving a first plurality of stationary structural members into the ground at fixed positions relative to one another, removing the jig from the first plurality of stationary structural members, repositioning the jig to a desired position; and repeating the steps of using the jig as a guide, driving a second plurality of stationary members into the ground and removing the jig.

The foregoing features and the operation of the invention will become more apparent in light of the following description and the accompanying drawings.

### BRIEF DESCRIPTION OF THE DRAWINGS

FIG. 1 illustrates a solar panel installation that includes a plurality of solar panel arrays;

FIG. 2 illustrates an alternative embodiment of a solar panel installation that includes a plurality of solar panel arrays;

FIG. 3 is a perspective view of an exemplary embodiment of a stationary structural member with a mounting assembly attached thereto;

FIG. 4 is a side perspective view of the stationary structural member with the mounting assembly of FIG. 3 attached thereto;

FIG. 5 is a bottom perspective view of the stationary structural member with the mounting assembly of FIG. 3 attached thereto;

FIG. 6 is a perspective view of an exemplary embodiment of a clamping bracket;

FIG. 7 is a perspective view of an exemplary embodiment of a first mounting plate;

FIG. 8 is a perspective view of an exemplary embodiment of a lower swivel plate;

FIG. 9 is a perspective view of an exemplary embodiment of an upper swivel plate;

FIG. 10 is a first perspective view of a bolt according to a first exemplary embodiment;

FIG. 11 is a pictorial illustration of a first exemplary embodiment of a clamp;

FIG. 12 is a first perspective view of the bolt of FIG. 10 and the clamp of FIG. 11 operatively secured by a fastener;

FIG. 13 is a second perspective view of the bolt of FIG. 10 and the clamp of FIG. 11 operatively secured thereto;

FIG. 14 is a perspective view of an exemplary embodiment of a second mounting plate;

FIG. 15 is a pictorial illustration of two panels attached to the mounting assembly;

FIG. 16 is a top perspective view of four panels clamped to the mounting assembly of FIGS. 3-5;

FIG. 17 is a flow chart illustration of a method of installing stationary structural members of a solar panel racking structure;

FIG. 18 is atop view of a first exemplary embodiment of a jig for use in the method of installing stationary structural members of a solar panel racking structure;

FIG. 19 is a perspective view of a second exemplary embodiment of a jig for use in the method of installing structural members of a solar panel racking structure;

FIG. 20 is a perspective view of a corner region of the jig illustrated in FIG. 19; and

FIG. 21 is a top view of the jig illustrated in FIG. 19.

### DETAILED DESCRIPTION

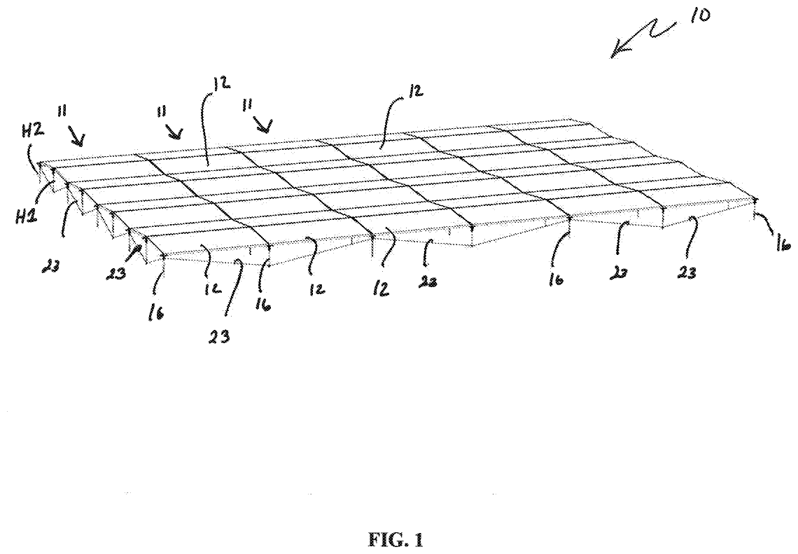

FIG. 1 illustrates a solar panel installation 10 that includes a plurality of solar panel arrays 11, which includes one or more solar panels 12 (e.g., a linear array of solar panels) mounted to a racking structure 16. Each racking structure 16 includes a plurality of stationary structural members 22 that each includes a mounting assembly that is mounted to the stationary structural member.

Each of the stationary structural members 22 located along the periphery of the solar panel installation 10 includes diagonal bracing to strengthen the solar panel array installation. For example, diagonal braces 23 extend in an alternating ascending/descending diagonal arrangement between stationary structural members 22 located along the periphery of the installation 10. The diagonal bracing components 23 may include, for example, wire cable, straps, rods, et cetera, tensioned as desired to strengthen the solar panel installation 10. In an alternative embodiment, two diagonal bracing components, one ascending and one descending, may be used between adjacent stationary structural members. Each of the stationary structural members is driven into the ground to a desired depth. In an exemplary embodiment, the stationary structural members are arranged in rows running substantially north-south (N—S), for example within +10 degrees of N—S.

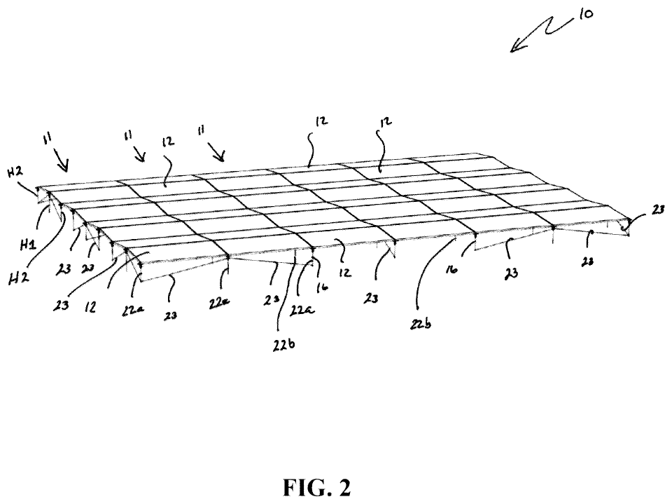

FIG. 2 illustrates an alternative embodiment solar panel installation that includes a plurality of solar panel arrays. This embodiment is substantially the same as the embodiment in FIG. 1, with the principle exception that the diagonal braces 23 are not used between all adjacent stationary structural members. In this embodiment, the stationary structural members include a plurality of primary stationary structural members 22a comprising diagonal structural bracing 23 extending from a top of a first of the plurality of primary stationary structural members to the base of an adjacent second of the plurality of primary stationary structural members to restrain horizontal motion at the top of the first of the plurality of primary stationary structural members. The stationary structural members also include a plurality of secondary stationary structural members 22b that are unsupported by diagonal bracing extending from the plurality of stationary structural members. This facilitates the primary stationary structural members carrying horizontal load from the top of the primary vertical elements into the array foundation (e.g., the ground).

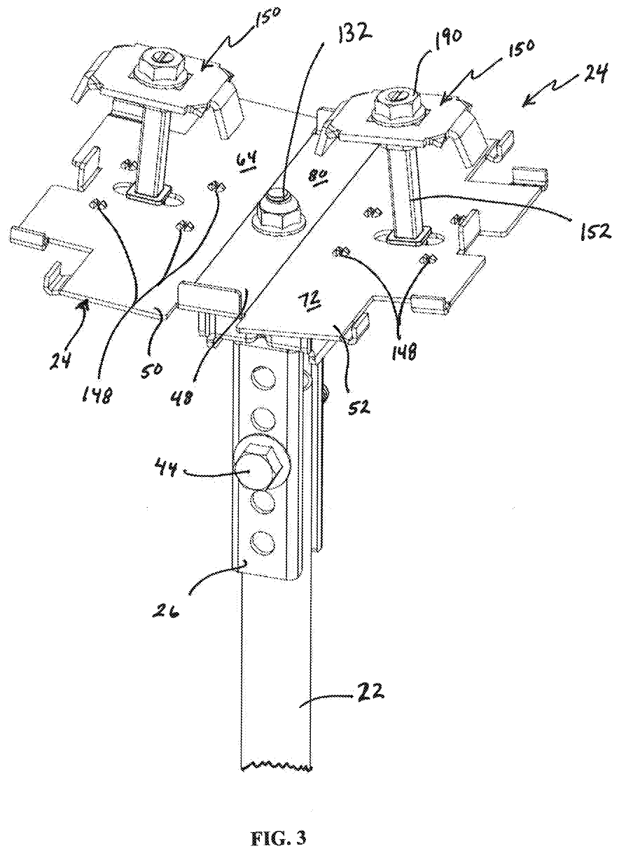

FIG. 3 is a perspective view of an exemplary embodiment of a stationary structural member 22 and a mounting assembly 24 attached thereto. In this embodiment the stationary structural member 22 comprises a cylindrical tube. However, rather than a circular cross section it is contemplated that the stationary structural member may have a hollow polygonal (e.g., square) cross-sectional geometry.

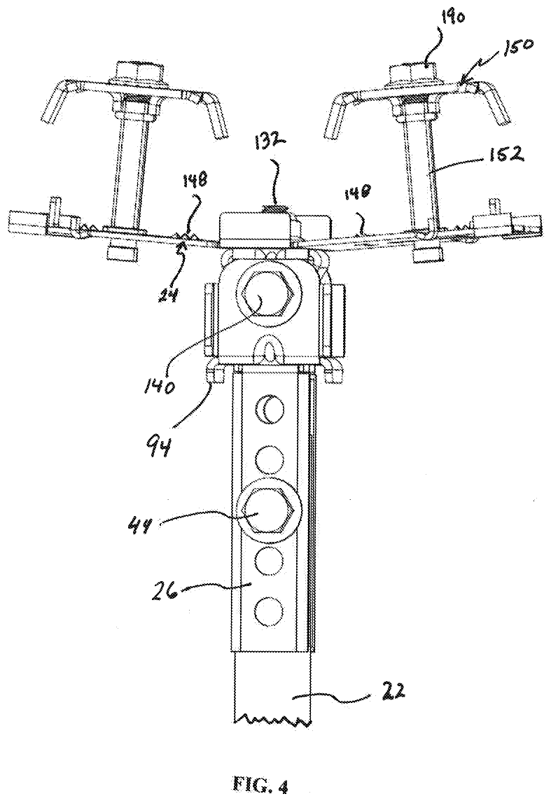

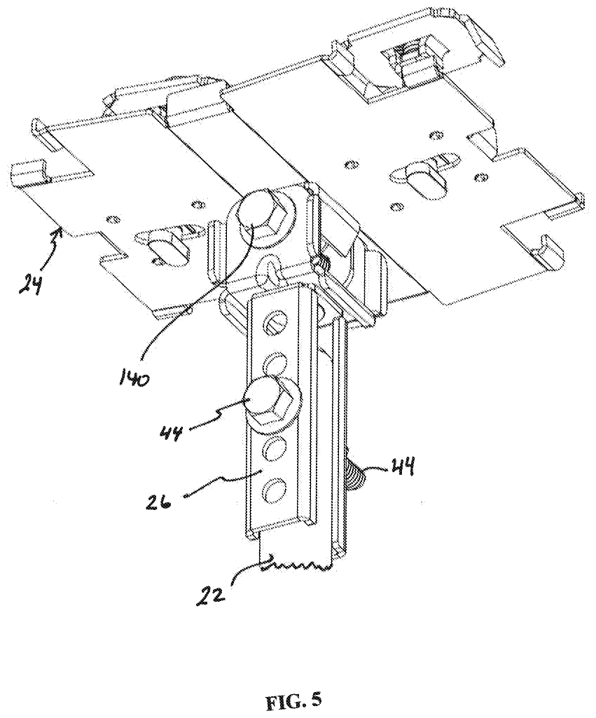

FIG. 4 is a side perspective view of the stationary structural member 22 with the mounting assembly 24 attached thereto. FIG. 5 is a bottom perspective view of the stationary structural member 22 with the mounting assembly 24 attached thereto. The components of the mounting assembly 24 shall now be discussed. In an exemplary embodiment the mounting assembly 24 includes a clamping bracket, a mounting plate, a lower swivel plate, an upper swivel plate and a plurality of fasteners.

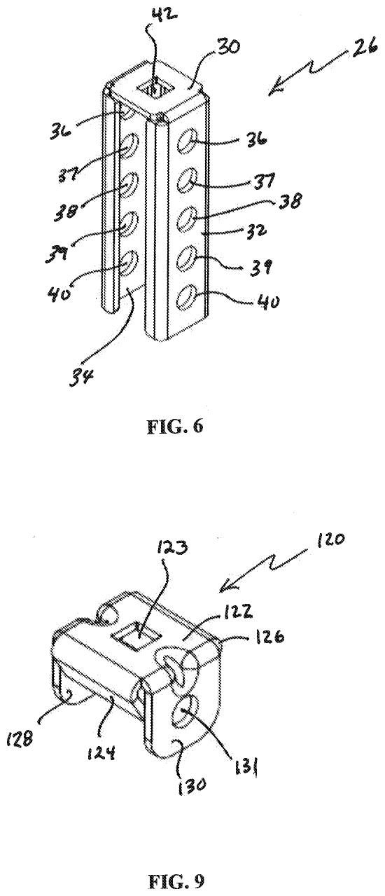

FIG. 6 is a perspective view of an exemplary embodiment of a clamping bracket 26, which may be U-shaped and include a top surface 30 and opposing sidewalls 32, 34 extending from the top surface 30. The opposing sidewalls 32, 34 include a plurality of co-axial opening pairs 36-40. The top surface 30 includes a top surface opening 42. In one embodiment, the top surface opening 42 is square or rectangular to accept a carrier bolt. Referring to FIGS. 3-5, the clamping bracket 26 may be secured to the stationary structural member 22 via a fastener 44 (e.g., a threaded bolt and nut) that passes through one of the co-axial opening pairs 36-40 and a clamping mounting opening in the stationary structural member 22. The plurality of co-axial opening pairs 36-40 in the opposing sidewalls 32, 34 of the clamping bracket allow the top surface 30 of the clamping bracket to be positioned at the desired height on the stationary structural member 22.

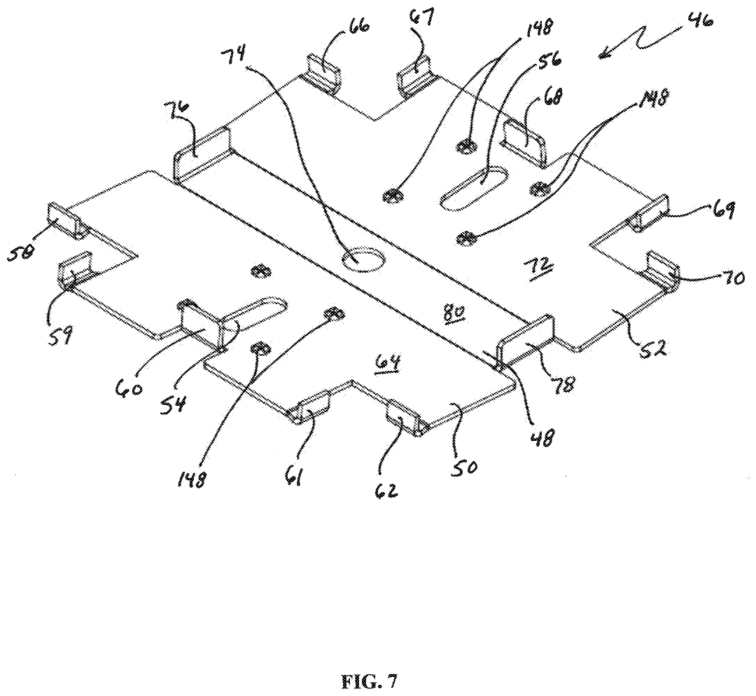

FIG. 7 is a perspective view of an exemplary embodiment of a mounting plate 46, which includes a central segment 48, a first side segment 50 and a second side segment 52. The central segment 48 may be a planar surface. The first and second side segments 50, 52 extend from opposite exterior surfaces of the base segment 48. The first side segment 50 includes a first slot 54, and the second side segment 42 includes a second slot 56. The first and second slots 54, 56 will be discussed in more detail below with a clamp assembly that is used to secure the solar panels 12 (FIGS. 1-2) to the mounting plate 46 (FIG. 3). The first side segment 50 includes a plurality of positioning tabs 58-62 that extend substantially perpendicularly (e.g., 70-110 degrees) from a surface 64 of the first side segment 50. Similarly, the second side segment 52 includes a plurality of positioning tabs 66-70 that extend substantially perpendicularly (e.g., 70-110 degrees) from a surface 72 of the second side segment 52. The central segment 48 includes a central surface opening 74 (e.g., centrally located) and opposing positioning tabs 76, 78 that extend substantially perpendicularly from a central surface 80. The mounting plate 46 may be metallic (e.g., galvanized steel), but is contemplated non-metallic materials may be used. The mounting plate 46 may be a unitary (i.e., single piece) structure. The positioning tabs 58-62 and 66-70 are positioned and sized to compliment the underside of a solar panel frame.

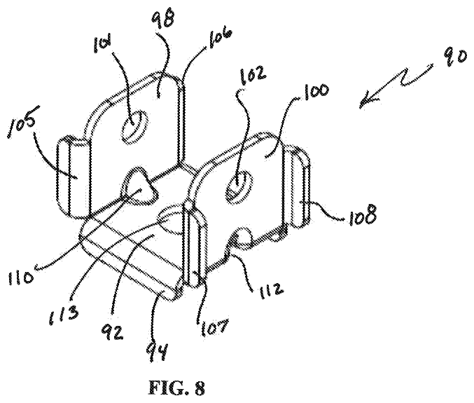

To provide angular correction during installation, each mounting assembly may have one or more degrees of adjustability to provide angular correction. In an exemplary embodiment, the mounting assembly may be configured as a gimbal arrangement. The mounting assembly 24 (FIGS. 3-5) may also include a lower swivel plate. FIG. 8 is a perspective view of an exemplary embodiment of a lower swivel plate 90 that includes a lower swivel plate base surface 92 from which opposing tabs 94, 96 extend downwardly for strength of the lower swivel plate. The plate 90 also includes opposing sidewalls 98, 100 that extend substantially perpendicularly upwardly from the lower swivel plate base surface 92. The opposing sidewalls 98, 100 include coaxial fastener openings 101, 102, respectively. Each of the sidewalls 98, 100 may also include opposing tabs 105, 106 and 107, 108, respectively, for strength of the lower swivel plate. Each of the opposing tabs 105-108 may extend outwardly substantially perpendicularly from the associated sidewall 98, 100. Gussets 110, 112 may also be positioned in the seams between the plate base surface 92 and each of the opposing sidewalls 98, 100. The base surface 92 also includes a fastener opening 113.

FIG. 9 is a perspective view of an exemplary embodiment of an upper swivel plate 120 that includes an upper swivel plate base surface 122 from which opposing tabs 124, 126 extend. The opposing tabs 124, 126 act as stiffeners. The upper swivel plate base surface 122 also includes a through hole 123. In one embodiment the through hole 123 is square, which keeps a carriage bolt locked. The square through hole 123 coaxially cooperates with a central surface opening 74 (e.g., circular) on the central segment of the mounting plate 46 (FIG. 6) to accept a carrier bolt. The opposing tabs 124, 126 include radiused edges of more than 90 degrees that align the opposing tabs 124, 126 slightly inward. The upper swivel plate 120 also includes opposing sidewalls 128, 130 that extend substantially perpendicularly from the swivel plate surface 122 and each includes an associated coaxial fastener through hole 131.

In an exemplary embodiment the mounting assembly 24 (FIG. 3) includes the clamping bracket 26 (FIG. 6), the mounting plate 46 (FIG. 7), the lower swivel plate 90 (FIG. 8) and the upper swivel plate 120 (FIG. 9). Assembly of the mounting assembly 24 shall now be discussed, and then securing of the mounting assembly to the stationary structural member 22 (FIG. 3). However, in one embodiment that does not include the swivel plates, the clamping bracket 26 is fastened to the stationary structural member and the mounting plate 46, 200 is fastened to the top surface 30 of the clamping bracket 26. Based upon the actual height of each stationary structural member, the particular coaxial opening pair 36-40 (FIG. 6) is selected to be coaxial with the clamping mounting opening in the stationary structural member and the fastener 44 (FIG. 3) (e.g., a thread bolt and nut) is used to secure the clamping bracket 26 to the stationary structural member 22.

Referring to FIGS. 3, 7 and 9, to assemble the mounting assembly 24 (FIG. 3), the mounting plate 46 (FIG. 7) is attached to the upper swivel plate 120 (FIG. 9) using a fastener 132. The fastener 132 may be, for example, a carrier bolt with a threaded distal end and threaded nut. With the underside of the central segment 48 (FIGS. 3 and 7) adjacent to the upper swivel plate base surface 122, the carrier bolt is inserted through the hole 123 (FIG. 9) and then through the opening base surface opening 74 (FIG. 7) of the mounting plate 24. A nut is threaded onto the distal end of the bolt to secure the swivel plate base surface 122 (FIG. 9) against the underside of the mounting plate 46 (FIG. 7). This forms a first sub-assembly.

Next, referring to FIGS. 6 and 8, the lower swivel plate 90 (FIG. 8) is secured to the clamping bracket 26 (FIG. 6). The underside of the lower swivel plate base surface 92 (FIG. 8) is placed against the top surface 30 of the clamping bracket 26 (FIG. 6) such that the top surface opening 42 of the clamping bracket 26 aligns with the fastener opening 113 of the lower swivel plate base surface 92 (FIG. 8). A threaded bolt is inserted through the top surface opening 42 of the clamping bracket 26 and through the fastener opening 113 of the lower swivel plate base surface 92 (FIG. 8). A nut is threaded onto the distal end of the bolt to secure the lower swivel plate 90 (FIG. 8) against the clamping bracket 46. This forms a second sub-assembly.

The second sub-assembly is attached to the associated stationary structural member 22 by positioning the distal end of the stationary structural member between the opposing sidewalls 32, 34 (FIG. 6) of the clamping bracket 46 and securing the second sub-assembly to the stationary structural member 22. The fastener 44 (e.g., a threaded bolt and nut) is inserted through a selected one of the coaxial opening pairs 36-40 (FIG. 6) based upon the desired height of the clamping bracket top surface 30 (FIG. 6).

In a first degree of adjustability during installation of the stationary structural member and the associated mounting assembly, the fastener connecting the clamping bracket 26 (FIG. 4) and the lower swivel plate 90 (FIG. 8) is loosened and the lower swivel plate rotated such that sidewalls of the lower swivel plate are parallel to the direction the stationary structural is leaning. The fastener is then torqued the desired amount to lock the lower swivel plate in position.

Next, the first and second sub-assembles are then brought together to form the mounting assembly 24 by inserting a threaded bolt 140 (FIG. 5) through the coaxial openings 101, 102 of the lower swivel plate 90 (FIG. 8) and the coaxial openings 131 in the opposing sidewalls 128, 130 of the upper swivel plate 120 (FIG. 9), which is coaxially nested within the lower swivel place 90 (FIG. 8). A threaded nut is secured to the threaded distal end of the threaded bolt 140 (FIG. 5).

In a second degree of adjustability during installation, with the mounting assembly stationary structural member, the fastener 140 (FIG. 4) is loosened and the swivel plate upper 120 is rotated such that the mounting plate 46 is level. The fastener 140 is then tightened (e.g., hand tightened). In one embodiment the nuts used in fasteners of the mounting assembly 24 are nyloc nuts.

In a third degree of adjustability during installation, the mounting plate 46 is rotated such that it is aligned within, e.g., ±1 degree of project azimuth. The nut of the fastener 132 is then torqued to secure the mounting plate 46 in the desired position with respect to the project azimuth.

Referring now to FIGS. 3-5, the mounting assembly 24 is secured to the stationary structural member 22 by inserting a threaded bolt of the fastener 44 through a selected one of the co-axial opening pairs 36-40 in the opposing sidewalls 32, 34 of the clamping bracket 26 (FIG. 6) and the clamp mounting opening 41 in the stationary structural member 22 (FIGS. 3-5). This provides yet another degree of adjustability during installation. With the mounting plate assembly 24 installed on the stationary structural member 22, the solar panels 12 can now be mounted.

Referring to FIGS. 1-2, the solar panels 12 are each arranged at a non-horizontal angle so rain washes dust and debris off the face of the panel. This can be controlled by the length of the stationary structural member 22 extending above the ground, and the coaxial opening pairs 36-40 used to fasten the clamping bracket 26 to the stationary structural member. Adjacent arrays alternate extending slightly upwardly and downwardly (i.e., a positive angle of attack followed by a negative angle of attack, and repeating). In one embodiment, the stationary structural members 22 in even numbered rows may have a height H1 above the ground, and the stationary structural members 22 in immediately adjacent odd numbered rows may have a height H2, where H1 is not equal to H2.

Referring again to FIG. 7, one or more of the mounting plate surfaces 64, 72 may include serrated projections 148 that bite into the frame of the solar panel for electrical bonding. The serrated projections 148 also create friction between the frame of the solar panel and the mounting plate, which facilitates the primary stationary structural members carrying horizontal load from the top of the primary vertical elements into the array foundation.

The arrangement of the clamping bracket 26 and the lower and upper swivel plates 90, 120 allows the mounting assembly 24 to operate as a gimbal, which reduces bending stress that would otherwise be felt by the neck between the clamping bracket and the mounting plate. In addition, mounting plate 46 (FIG. 7) is configured to transfer horizontal load from one solar panel to an adjacent solar panel supported on the same plate such that the array of panels and plates acts as a horizontal diaphragm. That is, when the nuts on the bolts supporting the clips are torqued down the teeth on the panel clamps, to be discussed below, bite into the panels and friction is created between the bottom of the panel frame and the plates. This in combination with the serrated projections 148 (FIG. 7) and the tabs 58-62, 66-70 perpendicular to the mounting plate surfaces create three different mechanisms to transfer lateral load from a panel into the plate and then into the adjacent panel. In this way, horizontal load can be transferred from one side of the array to another where a stiffer stationary support (e.g., primary stationary structural support 22a illustrated in FIG. 2) may be located.

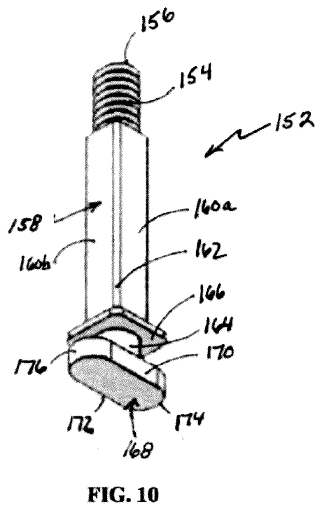

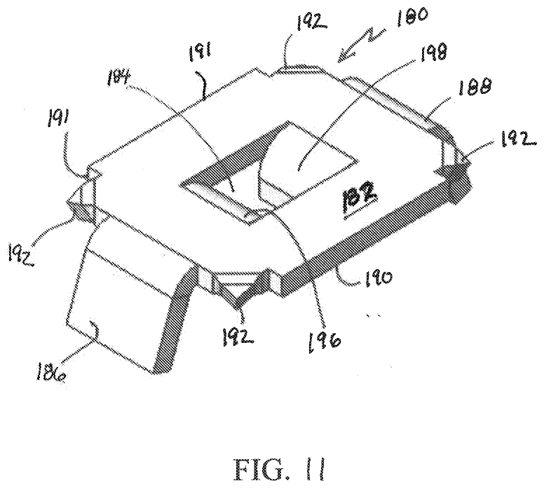

Referring again to FIGS. 3-6, a panel clamp 150 is used to mount the solar panels 12 (FIGS. 1-2) to the mounting assembly 24 (FIGS. 3-6). In an exemplary embodiment the panel clamp 150 may be the panel clamp disclosed in U.S. Patent Application Publication US20220010822A1, entitled “Apparatuses and Assemblies for a Solar Panel Installation with a T-Bolt and Clamp”, to Gamechange Solar Corp., which is hereby incorporated by reference. FIG. 10 is a first perspective view of a bolt according to a first exemplary embodiment. The panel clamp 150 includes a bolt 152 comprising an externally threaded segment 154 at a proximate axial end 156 of the bolt, and a first shank segment 158 axially adjacent to the externally threaded segment 154. The first shank segment 158 comprises a plurality of sidewalls 160a-160d (only sidewalls 106a and 106b shown), where each adjacent ones of the plurality of sidewalls are separated by a radiused edge 162. It is contemplated that the first shank segment 158 may be one of various cross-sectional shapes including polygonal, cylindrical, multiple radii or even a combination of various cross-sectional shapes. The plurality of sidewalls may have planar surfaces, but of course other curved or other surfaces may be used. The bolt 152 also includes a second shank segment 164, and a bolt flange 166 radially extending from the first shank segment 158 and axially located between a distal end of the first shank segment 158 and a proximate end of the second shank segment 164. A head 168 is axially adjacent to a distal end of the second shank segment 164.

The head 168 may be configured to provide a T-bolt. For example, the head may comprise first and second parallel/opposing sidewalls 170, 172, a first radiused wall 174 separating the first and second parallel/opposing sidewalls 170, 172 at a first end, and a second radiused wall 176 separating the first and second parallel/opposing sidewalls at a second end. This is generally referred to as stadium shaped (i.e., constructed of a rectangle with semicircles at a pair of opposite sides). Of course, the shape of the head 168 is not limited to the foregoing exemplary configuration. It is contemplated that the head 168 may be one of various known shapes, including oval, oblong, et cetera.

FIG. 11 is a pictorial illustration of a first exemplary embodiment of a clamp 180 (e.g., a mid-clamp used for the installation of solar panels into a mounting rack). The clamp 180 includes a base surface 182 that has a central opening 184 formed therein and elongated downwardly bent side portions 186, 188 that extend from the base surface 182. The clamp also includes clamp flanges 190, 192. The central opening 184 may be polygonal, circulator or oblong shaped and sized to allow the externally threaded segment 154 of the bolt 152 (FIG. 10) to pass through the central opening 184.

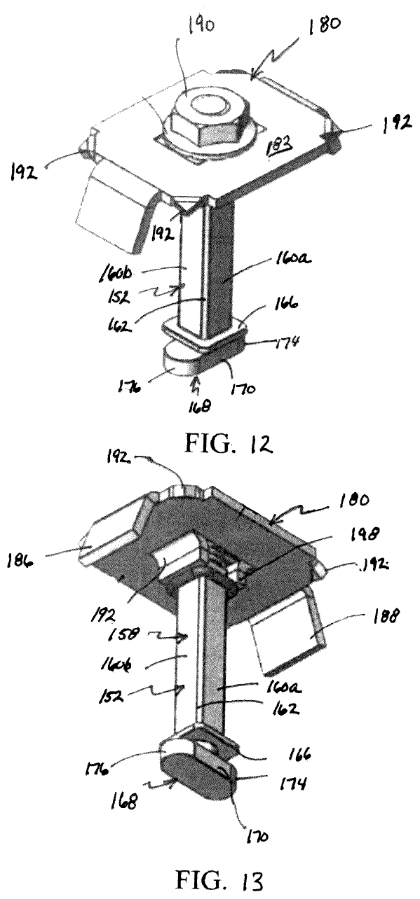

FIG. 12 is a first perspective view of the bolt 152 and the clamp 180 operatively secured to the bolt with a fastener (e.g., a serrated flange nut) 190. The nut 190 may include a serrated bottom surface. In addition, the clamp 180 may also include a plurality of serrated edges 192 that point downwardly from the plane formed by the base surface 182, such that when the nut 190 is torqued the desired amount the serrated edges 192 bite into the object being clamped. Of course, the size and shape of the central opening 184 in the base surface 182 of the clamp 180 is large enough to allow the externally threaded segment 154 (FIG. 10) to pass, but not so large that the fastener 190 does not contact sufficient area of the base surface 182 when torqued down. FIG. 13 is a second perspective view of the bolt 152 of FIG. 10 and the clamp 180 of FIG. 11 operatively secured thereto. The serrated edges 192 create friction between the frame of the solar panel and the clamp 180 secured to the mounting plate. This further facilitates the primary stationary structural members 23a (FIG. 2) carrying horizontal load from the top of the primary vertical elements into the array foundation.

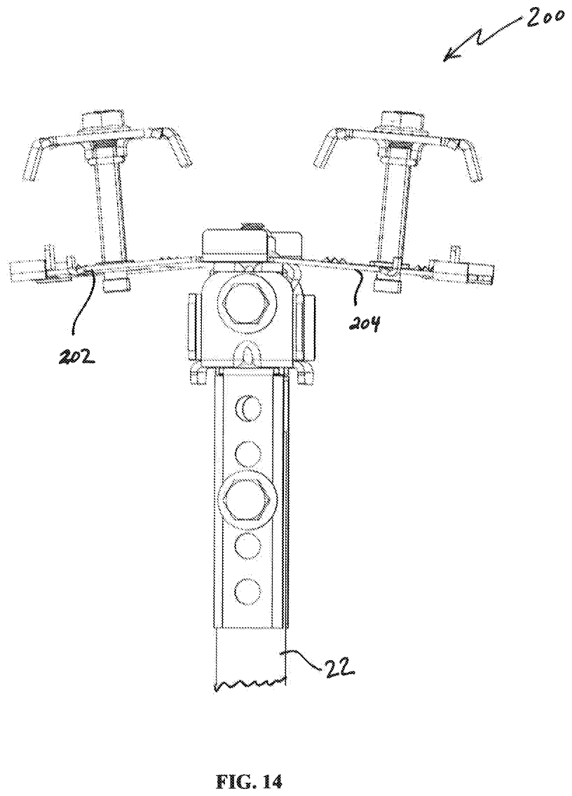

FIG. 14 is a perspective view of an exemplary embodiment of a second mounting plate 200. The second mounting plate 200 is substantially the same as the first mounting plate 46 illustrated in FIG. 7 with the principal exception that the first and second side segments 202, 204 in the second mounting plate pitched slightly downwardly from the base segment. As discussed above, referring to FIGS. 1-2, the solar panels 12 are each arranged at a non-horizontal angle so rain washes dust and debris off the face of the panel. This can be controlled by the length of the stationary structural member 22 extending above the ground and the coaxial opening pairs 36-40 used to fasten the clamping bracket 26 to the stationary structural member. Adjacent arrays alternate extending slightly upwardly and downwardly (i.e., a positive angle of attack followed by a negative angle of attack, and repeating). In one embodiment, the stationary structural members 22 in even numbered rows may have a height H1 above the ground, and the stationary structural members 22 in odd numbered rows may have a length H2, where H1 is not equal to H2. Accordingly, the mounting plates for adjacent rows will alternative between the first mounting plate 46 of FIG. 7 and the second mounting plate 200 of FIG. 14.

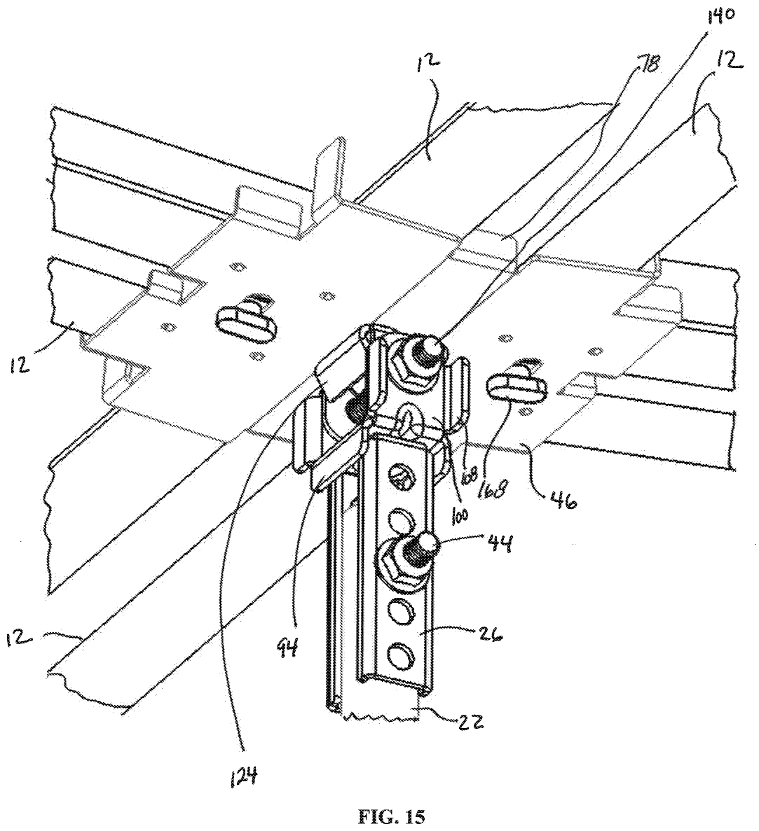

FIG. 15 is a pictorial illustration of two photovoltaic panels 12 attached to the mounting assembly 24.

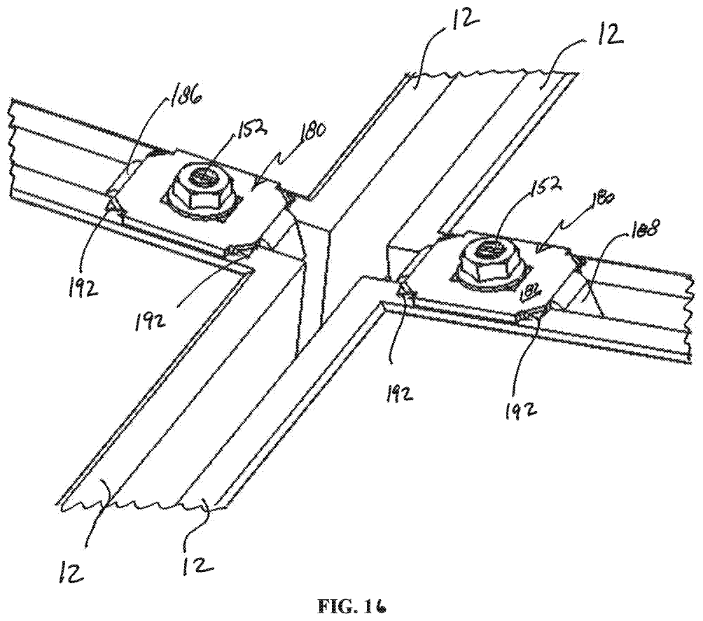

FIG. 16 is a top perspective view of four photovoltaic panels 12 clamped to the mounting assembly.

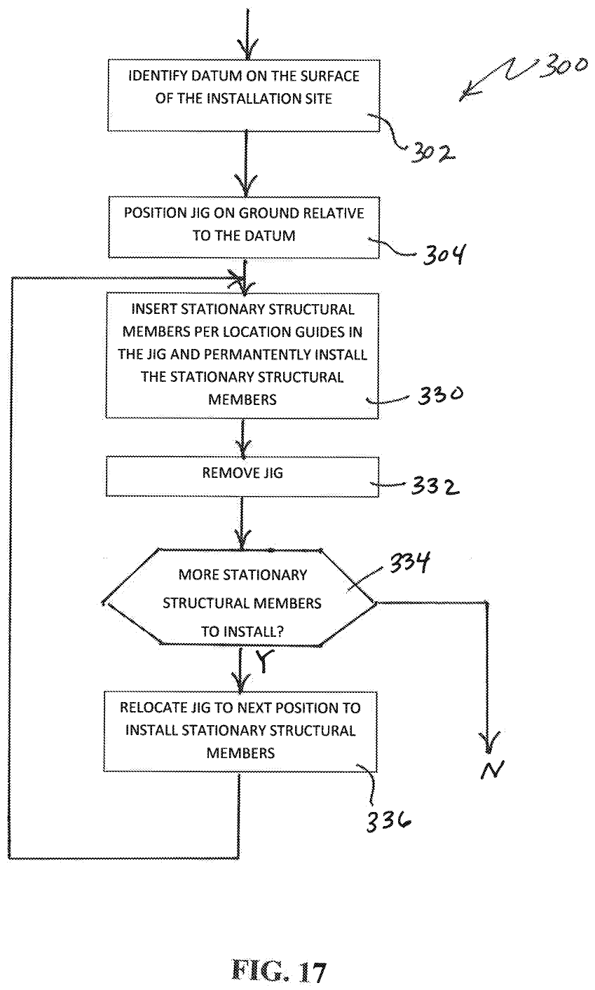

FIG. 17 is a flow chart illustration for a method 300 for installing stationary structural members 22 (FIGS. 1-5, 14 and 15) of a solar panel racking structure. In step 302, a datum and an azimuth are identified (e.g., by a surveyor) on the site for installation of the stationary structural members 22. In step 304, a jig is then positioned on the ground relative to the datum and the azimuth for installation of stationary structural members.

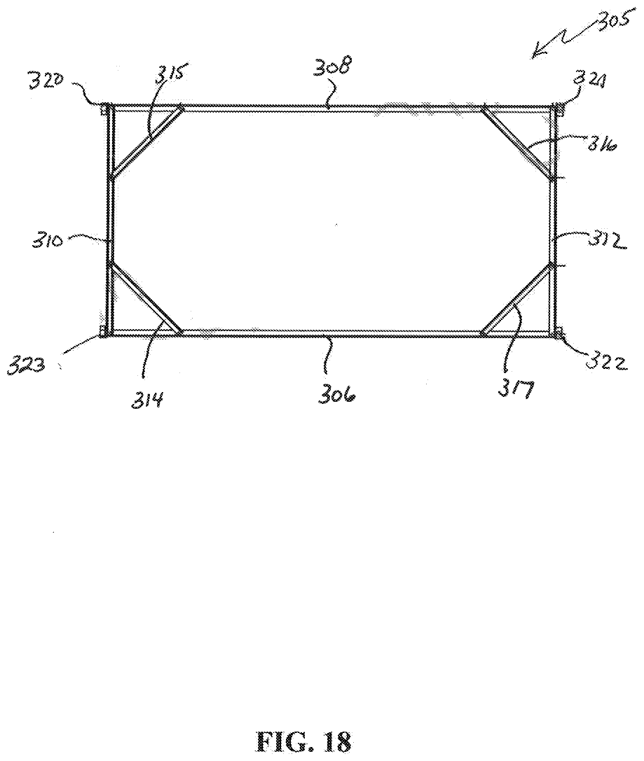

FIG. 18 is a top view of a first exemplary embodiment of a jig 305 for use in the method of installing stationary structural members of a solar panel racking structure. In this exemplary embodiment, the jig 305 is shaped as a rectangle with first and second parallel legs 306, 308 of equal length, and third and fourth parallel legs 310, 312 positioned perpendicular with respect to the first and second parallel legs 306, 308. Each of the legs may be formed, for example, from L angle steel. However, a skilled person will recognize that many different materials may be used. The legs may be secured at each corner with a fastener (e.g., a threaded bolt and nut). For rigidity of the jig, a diagonal reinforcement 314-317 may be added to each corner. The diagonal reinforcements 314-317 may also be L-angle steel. Eyelets 320-323 are attached to the jig, and the eyelets act as guides for the stationary structural members to be installed into/on the ground. The eyelet may be located on the interior or exterior side of each corner of the jig.

While the jig of FIG. 18 allows the user to position four (4) stationary structural members without repositioning of the jig, it is contemplated that the jig may be larger to accommodate for example the installation of eight (8) or sixteen (16) stationary structural members without repositioning the jig 305.

Referring to FIG. 17, with jig properly positioned in step 304, in step 330 the stationary structural members 22 are inserted through eyelets 320-323 (FIG. 18) into the ground. In one embodiment, the eyelets 320-321 receive the stationary structural members 22 of length H2 and the eyelets 322-323 receive the stationary structural members of length H1. With each of the four stationary structural members mounted into the ground through its respective eyelet, in step 332 the jig is then removed (e.g., lifted such that each eyelet no longer surrounds its respective stationary structural member). In step 334, if more stationary structural members remain to be installed, then the jig is repositioned in step 336 for installation of another plurality of stationary structural members, and this process is repeated until all the stationary structural members are installed. It is worth nothing that after the first plurality of stationary structural members are installed in step 330, that they may become a new datum of installation of a second plurality of stationary structural members, then the second plurality of stationary structural members become a datum for the third plurality of stationary structural members, etc., until all the stationary members are installed. Notably, the jig allows installers to reduce/minimize use of a plurality of surveyed datums (e.g., see the step 302 in FIG. 17).

It is contemplated that the jig may take a number of different forms, such as for example, an open form with diagonals, open form with horizontal cross braces, a continuous sheet (e.g., a sheet of plywood), etc. It is contemplated that the eyelets may be formed from pieces of pipe/tubing, eyebolts, circular clamps, clamps with piano hinges, etc. In addition, it is contemplated that the eyelets may be telescopic in the vertical direction to assist with leveling the jig.

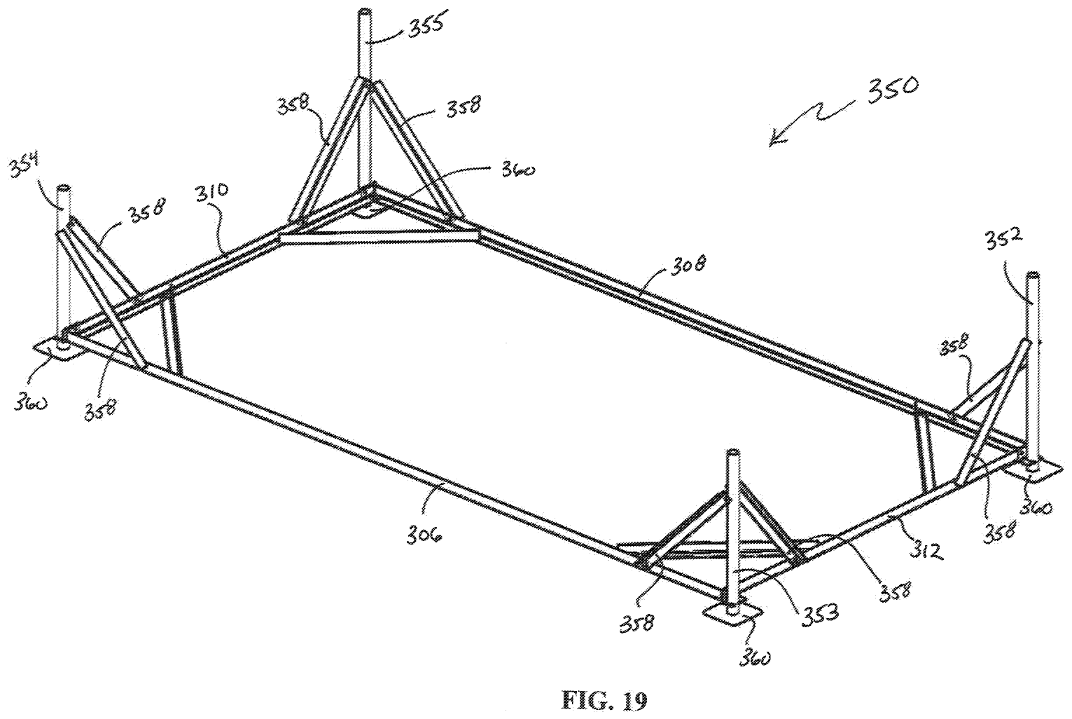

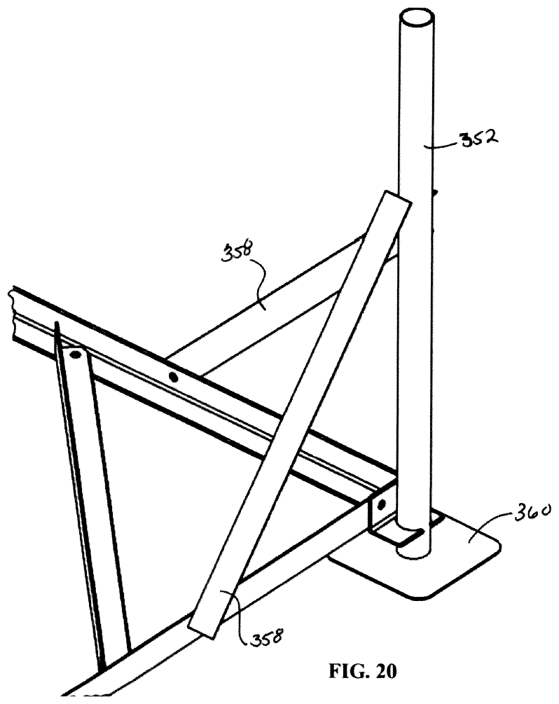

FIG. 19 is a perspective view of a second exemplary embodiment of a jig 350 for use in the method of installing structural members of a solar panel racking structure. The jig 350 is substantially similar to the jig 305 illustrated in FIG. 18, with the principal exception that the jig 350 illustrated in FIG. 19 includes tubing elements 352-355 for positioning and guiding the stationary structural members during installation, rather than the eyelets 320-332 used in the jig 305 embodiment illustrated in FIG. 18. Each tubing element 352-355 includes one or more brackets 358 to maintain each tubing element in its proper orientation. Each tubing element 352-355 extends through an associated ground pad 360.

FIG. 20 is a perspective view of a corner region of the jig illustrated in FIG. 19.

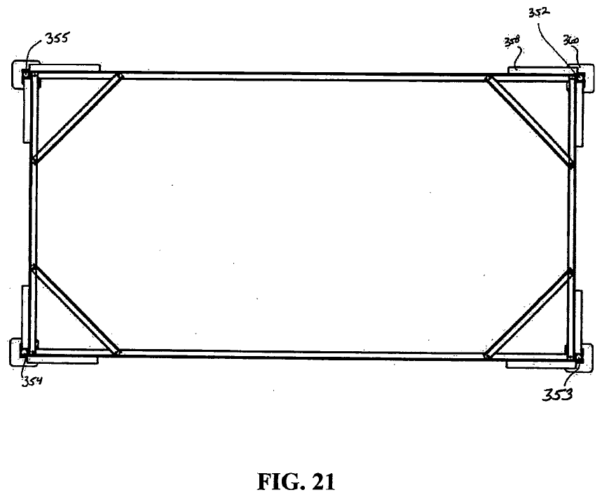

FIG. 21 is a top view of the jig illustrated in FIG. 19.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. A method of installing stationary structural members of a solar panel racking structure, the method comprising:
positioning a jig on a surface relative to a datum on the surface;
using the jig as a guide and driving a first plurality of stationary structural members into the ground at fixed positions relative to one another;
removing the jig from the first plurality of stationary structural members;
repositioning the jig to a desired position relative to the datum; and
repeating the steps of using the jig as a guide, driving a second plurality of stationary members into the ground and removing the jig.

2. The method of claim 1, where the using the jig as a guide and driving comprises driving each of the first plurality of stationary members into the ground through an associated one of a plurality of guides located on the jig.

3. The method of claim 1, where the using the jig as a guide and driving comprises driving each of the first plurality of stationary members into the ground through an associated one of a plurality of eyelets located on the jig.

4. The method of claim 1, where the using the jig as a guide and driving comprises driving each of the first plurality of stationary members into the ground through an associated one of a plurality of tubing segments located on the jig.

5. The method of claim 2, where the step of removing comprises lifting the jig so each of the plurality of guides no longer surrounds its associated one of the first plurality of stationary structural members.

6. The method of claim 5, where the jig is rectangular and the guides are mounted to exterior corners of the rectangular jig, and the step of using the jig as a guide and driving a first plurality of stationary structural members into the ground comprises driving a first and a second stationary structural member of the first plurality of stationary structural members into the ground such that a top surface of each of the first and the second stationary structural members is a height H1 above the ground, and driving a third and a fourth stationary structural member of the first plurality of stationary structural members into the ground such that a top surface of each of the third and the fourth stationary structural members is a height H2 above the ground, where height H1 is not equal to height H2.

7. A method of installing stationary structural members of a solar panel racking structure, the method comprising:
positioning a jig on a surface relative to a datum on the surface;
using the jig as a guide and driving a first plurality of stationary structural members into the ground at fixed positions relative to one another;
removing the jig from the first plurality of stationary structural members;
repositioning the jig to a desired position relative to the first plurality of stationary structural members; and
repeating the steps of using the jig as a guide, driving a second plurality of stationary members into the ground and removing the jig.

8. A method of installing stationary structural members of a solar panel racking structure, the method comprising:
positioning a jig on a surface relative to a datum on the surface;
using the jig as a guide and driving a first plurality of stationary structural members into the ground at fixed positions relative to one another;
removing the jig from the first plurality of stationary structural members;
repositioning the jig to a desired position; and
repeating the steps of using the jig as a guide, driving a second plurality of stationary members into the ground and removing the jig.
